(19) United States
(12) Patent Application Publication
(10) Pub. No.: US 2016/0324152 A1
(43) Pub. Date: Nov. 10, 2016

(54) Compositions And Methods For Killing And/Or Immobilizing Insects

(71) Applicant: The United States of America, as represented by the Secretary of Agriculture, Washington, DC (US)

(72) Inventor: Jian Chen, Greenville, MS (US)

(21) Appl. No.: 15/146,234

(22) Filed: May 4, 2016

Related U.S. Application Data
(60) Provisional application No. 62/157,140, filed on May 5, 2015.

(51) Int. Cl. A01N 35/02; A01N 25/30

(52) U.S. Cl. CPC A01N 35/02; A01N 25/30

(57) ABSTRACT

A composition for killing and/or immobilizing insects, said composition containing 2-tridecanone, at least one solvent, at least one surfactant, piperonyl butoxide, and optionally a carrier. Also a method for killing and/or immobilizing insects, involving treating an object or area with an insect killing effective amount or insect immobilizing effective amount of a composition containing 2-tridecanone, at least one solvent, at least one surfactant, optionally butoxide, and optionally a carrier.

### REFERENCE TO RELATED APPLICATION

This application claims the benefit of U.S. Provisional Application No. 62/157,140 filed 5 May 2015, which is incorporated herein by reference in its entirety.

### BACKGROUND OF THE INVENTION

Disclosed herein are compositions containing 2-tridecanone, at least one solvent, at least one surfactant, optionally piperonyl butoxide, and optionally a carrier. Also disclosed are methods for killing and/or immobilizing insects, involving treating an object or area with an insect killing effective amount or insect immobilizing effective amount of the compositions described herein.

The red imported fire ant, Solenopsis invicta, is one of the most notorious invasive ants. Native to South America, S. invicta has been introduced into many countries and regions and has become a global pest (Ascunce, M. S., et al., Science, 331: 1066-1068 (2011)). Solenopsis invicta is not only a significant threat to public health but also an important pest in agriculture. The ecological impact of S. invicta is also significant (Porter, S. D., and D. A. Savignano, Ecology, 71: 2095-2106 (1990)). Solenopsis invicta is among the “100 World's Worst Invasive Alien Species” (Lowe, S., et al., 100 of the World's Worst Invasive Alien Species: A selection from the Global Invasive Species Database, Published by The Invasive Species Specialist Group (ISSG) a specialist group of the Species Survival Commission (SSC) of the World Conservation Union (IUCN), 2000, pages 1-12). Insecticides have been extensively used in controlling S. invicta. From the 1950s to the 1970s, insecticides, such as chlordane, heptachlor, dieldrin, and mirex were heavily used in the United States in attempts to eradicate the imported fire ants. After the failure of those eradication programs, tremendous effort has been made in developing alternatives for controlling imported fire ants, including biological control (Callcott, A. M. A., et al., J. Insect. Sci., 11:19 (2011); Oi, D. H., and S. M. Valles, Fire ant control with ntomopathogens in the USA, IN: Use of microbes for control and eradication of invasive arthropods, Springer Science+Business Media B.V., 2009, pages 237-257; Williams, D. F., and R. D. deShazo, Ann. Allergy Asthma Immunol., 93:15-22 (2004); Williams, D. F., et al., Am. Entomol., 49: 150-163 (2003)). Despite substantial success in developing biological control technologies, such as the introduction and establishment of phorid flies (Callcott et al. 2011) and the discovery of fire ant infecting fungal isolates, microsporidia and viruses (Oi and Valles 2009), chemical control using synthetic insecticides remains a major tool in controlling fire ants.

Surfactants, which are substances that can lower surface and interfacial tension, are commonly used in formulating synthetic insecticides and biopesticides to improve spreading, wetting, penetration, and stability. In addition to the effect as adjuvants, a few surfactants do have intrinsic toxicities against pest insects. However, it is unpredictable as to whether specific surfactants are insecticidal. In fact, surfactants are commonly considered as inert components in insect control products.

All surfactants combine hydrophilic and lipophilic groups in one molecule. According to the charge on the groups, surfactants can be classified as anionic, cationic, nonionic, or zwitterionic. Nonionic surfactants have no charges on two groups. The balance of the size and strength of these two opposing groups was termed as the hydrophilic-lipophilic balance (HLB) (Griffin, W. C., J. Soc. Cosmet. Chem., 1: 311-326 (1949)). Griffin (1954) developed a method to assign a value, the HLB number, to a nonionic surfactant. In Griffin's system, a surfactant that is lipophilic in character is assigned a low HLB number and a hydrophilic surfactant a high HLB number. Griffin's method is satisfactory for non-ionic surfactants of various chemical groups.

In addition to being used in guiding the selection of surfactants for formulating synthetic insecticides, the HLB number has also been used in selecting surfactants for formulating hydrophobic aerial conidia of entomopathogenic fungi, Beauveria bassiana and Metarhizium brunneum, from solid fermentation (Jin, X., et al., Biol. Control, 46: 226-233 (2008); Jin, X., et al., Biocontrol Sci. Techn., 19: 341-347 (2009)). An optimized surfactant can reduce wetting time, increase conidia counts in suspension, and promote synchronized conidial germination (Jin et al. 2009). It was found that polyoxyethylene tridecyl ether (Ethal TDA), a non-ionic surfactant, was a superior wetting agent for M. brunneum at HLB number of 8 (Jin et al. 2009). Ethal TDA HLB 8 has been used in formulating entomopathogenic fungi for controlling red imported fire ants (Jin, X., et al., Biocontrol Sci. Techn., 22: 233-241 (2012)). Ethal TDA surfactants have a general structure C₁₃H₂₇(OCH₂CH₂)ₙOH, where n is average moles of oxyethylene. Ethal TDA surfactants with different HLB numbers are commercially available, and surfactants with intermediate HLB numbers can be easily made through mixing of two Ethal TDAs with proper HLB numbers. They provide a convenient tool to study the relationship between biological effect of surfactants and HLB numbers with minimum change to their chemical property.

We have developed compositions containing 2-tridecanone, at least one solvent, at least one surfactant, optionally piperonyl butoxide, and optionally a carrier, that are surprising effective in killing and/or immobilizing insects. Also disclosed are methods for killing and/or immobilizing insects, involving treating an object or area with an insect killing effective amount or insect immobilizing effective amount of the composition.

### SUMMARY OF THE INVENTION

Disclosed herein are compositions containing 2-tridecanone, at least one solvent, at least one surfactant, optionally piperonyl butoxide, and optionally a carrier. Also disclosed are methods for killing and/or immobilizing insects, involving treating an object or area with an insect killing effective amount or insect immobilizing effective amount of the compositions described herein.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

FIG. 1 shows mortalities of Solenopsis invicta workers 24 h and 48 h after being topically treated with 77.9 μg/ant Ethal TDA surfactants with different HLB numbers as described below.

FIG. 2 shows mortalities of Solenopsis invicta workers 48 h after being treated with Ethal TDA surfactants with different HLB numbers at two concentrations (FIG. 2A: 0.018 μg/cm², FIG. 2B: 0.036 μg/cm²) in glass-vial bioassay as described below.

FIG. 3 shows mortalities of Solenopsis invicta workers after being immersed in 0.01% or 0.1% surfactants for 8 h as described below. Mortality was observed at 24 h and 48 h after the immersion. After being immersed in pure water for 8 h, ants had 8.89±2.00% mortality at 24 h and 10.56±1.55% at 48 h. All tested Ethal TDA surfactants caused significantly higher mortality than pure water at both concentrations except 24 mortalities for TDA with HLB number 11 and 12 at 0.01%.

FIG. 4 shows mean mortality (%) of S. invicta workers in immersion bioassay as described below.

### DETAILED DESCRIPTION OF THE INVENTION

Disclosed herein are compositions containing 2-tridecanone, at least one solvent, at least one surfactant, optionally piperonyl butoxide (which was surprisingly found to be a synergist), and optionally a carrier. Also disclosed are methods for killing and/or immobilizing insects, involving treating an object (includes the insects themselves) or area with an insect killing effective amount or insect immobilizing effective amount of the composition.

Numerous solvents have been used in formulating insecticides (Petrelli et al., Scan. J. Work Environ. Health, 19:63-65 (1993)). The solvent may be, for example, vegetable oil which is safe to humans and the environment. The surfactant is generally an Ethal TDA surfactant (nonionic) having the general structure C₁₃H₂₇(OCH₂CH₂)ₙOH, where n is average moles of oxyethylene. Ethal TDA surfactants with different HLB numbers are commercially available and surfactants with intermediate HLB numbers can be easily made through mixing of two Ethal TDAs with proper HLB numbers. Other surfactants may also useful, such as the following: (1) Anionic Surfactants (e.g., soaps, salts of fatty acids) which are negatively charged, and enhance foaming and other spreading properties. (2) Cationic Surfactants (e.g., alkyltrimethyl ammonium chloride) which are positively charged, although they are often very toxic to plants as they can disrupt membrane ion balance. (3) Amphoteric Surfactants (e.g., N-alkylbetaine) which are unusual in that they will form either a positive or negative charge in water, depending upon the pH of the solution (N-alkylbetaine). (4) Nonionic Surfactants (e.g., polyethylene oxide alkyl ether) which do not have a charge in solution and are the most commonly used surfactants for pesticides. When used properly, they as a class do not harm plants, remain stable, and do a good job of breaking water surface tension. However, application rate is critical. When applied at too high a rate plant injury may result.

Disclosed are methods to kill and/or immobilize insects (e.g., fire ants), involving treating (or exposing) an object (e.g., insects such as fire ants, buildings) or area (e.g., soil) with an insect killing and/or immobilizing effective amount of the compositions described herein. The terms “object” or “area” as used herein include any place where the presence of target pests is not desirable, including any type of premises, which can be out-of-doors, such as in gardens, lawns, tents, camping bed nets, camping areas, and so forth, or indoors, such as in barns, garages, commercial buildings, homes, and so forth, or any area where pests are a problem, such as in shipping or storage containers (e.g., luggage, bags, boxes, crates, etc.), packing materials, bedding, and so forth; also includes clothing.

The amount of the compounds or compositions used will be at least an effective amount. The term “effective amount,” as used herein, means the minimum amount of the compounds or compositions needed to kill and/or immobilize the insects when compared to the same area or object which is untreated. Of course, the precise amount needed will vary in accordance with the particular composition used; the type of area or object to be treated; and the environment in which the area or object is located. The precise amount of the composition can easily be determined by one skilled in the art given the teaching of this application. For example, one skilled in the art could follow the procedures utilized below; the composition would be statistically significant in comparison to a negative control. The composition may or may not contain a control agent for insects, such as a biological control agent or an insecticide known in the art to kill insects. Other compounds (e.g., insect attractants known in the art) may be added to the composition provided they do not substantially interfere with the intended activity and efficacy of the composition; whether or not a compound interferes with activity and/or efficacy can be determined, for example, by the procedures utilized below.

Compositions optionally contain a carrier or carrier material known in the art (e.g., agronomically or physiologically or pharmaceutically acceptable carrier). The carrier component can be a liquid or a solid material. As is known in the art, the vehicle or carrier to be used refers to a substrate such as a membrane, hollow fiber, microcapsule, cigarette filter, gel, polymers, septa, or the like. All of these substrates have been used to release insecticides in general and are well known in the art. Suitable carriers are well-known in the art and are selected in accordance with the ultimate application of interest. Agronomically acceptable substances include aqueous solutions, glycols, alcohols, ketones, esters, hydrocarbons halogenated hydrocarbons, polyvinyl chloride; in addition, solid carriers such as clays, cellulosic and rubber materials and synthetic polymers.

The compositions can therefore be used for killing and/or immobilizing insects such as harmful or troublesome blood-sucking, stinging and biting insects, ticks and mites. The term insects as used herein includes non-insects such as ticks and mites.

The blood-sucking insects include mosquitoes (for example Aedes, Culex and Anopheles species), sand flies (for example Phlebotomus and Lutzomyia species such as Phlebotomus papatasi), owl gnats (Phlebotoma), blackfly (Culicoides species), buffalo gnats (Simulium species), biting flies (for example Stomoxys calcitrans), tsetse flies (Glossina species), horseflies (Tabanus, Haematopota and Chrysops species), house flies (for example Musca domestica and Fannia canicularis), meat flies (for example Sarcophaga carnaria), flies which cause myiasis (for example Lucilia cuprina, Chrysomyia chloropyga, Hypoderma bovis, Hypoderma lineatum, Dermatobia hominis, Oestrus ovis, Gasterophilus intestinalis and Cochliomyia hominovorax), bugs (for example Cimex lectularius, Rhodnius prolixus and Triatoma infestans), lice (for example Pediculus humanus, Haematopinus suis and Damalina ovis), louse flies (for example Melaphagus orinus), fleas (for example Pulex irritans, Cthenocephalides canis and Xenopsylla cheopis) and sand fleas (for example Dermatophilus penetrans).

The biting insects include cockroaches (for example Blattella germanica, Periplaneta americana, Blatta orientalis and Supella supellectilium), beetles (for example Sitophilus granarius, Tenebrio molitor, Dermestes lardarius, Stegobium paniceum, Anobium puntactum and Hylotrupes bajulus), termites (for example Reticulitermes lucifugus), and ants (for example Lasius niger; and fire ants (e.g., genus Solenopsis, including S. richetri and S. invicta)).

The ticks include, for example, Ornithodorus moubata, Ixodes ricinus, Boophilus microplus and Amblyomma hebreum, and mites include, for example, Sarcoptes scabiei and Dermanyssus gallinae.

Preferably, the blood-sucking and biting insects, ticks and mites include mosquitoes, sand flies, biting flies (e.g., black flies, biting midges), bed bugs, ticks, and fire ants (genus Solenopsis; for example S. invicta, black imported fire ants S. richetri).

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a composition or property as provided herein is meant such amount as is capable of performing the function of the composition or property for which an effective amount is expressed. As will be pointed out below, the exact amount required will vary from process to process, depending on recognized variables such as the compositions employed and the processing conditions observed. Thus, it is not possible to specify an exact “effective amount.” However, an appropriate effective amount may be determined by one of ordinary skill in the art using only routine experimentation.

Any amounts, percentages, and ranges disclosed herein are not meant to be limiting, and increments between the recited amounts, percentages and ranges are specifically envisioned as part of the invention.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### Examples

We examined the response of S. invicta workers to six Ethal TDAs, with HLB numbers 7.9 to 13, in four different scenarios: (1) mortality after topical treatment, (2) mortality in a glass-vial with its inner wall coated with surfactant, (3) immobilization effect after being immersed in the surfactant water solutions, and (4) mortality after immersing treatment. In topical treatment, the actual amount of surfactant delivered to an ant body was well controlled, which is commonly used for studying the intrinsic toxicity of a chemical. Responses in glass-vial and immersing treatments are relevant to fire ant chemical control, such as mound drench and dipping treatment used in fire ant quarantine.

Ants: Red imported fire ant colonies were collected from Washington County, MS. Colonies were maintained in the same condition as described by Chen et al. (Chen. J, et al., J. Agri. Food Chem., 57: 3128-3133 (2009)). All colonies of S. invicta were free of Kneallhazia solenopsae, a microsporidian pathogen. The social form of red imported fire ant colonies was determined using PCR on Gp-9 alleles. The method described by Valles and Porter (2003) was used to amplify Gp-9 alleles (Valles, S. M., and S. D. Porter, Insectes Soc., 50: 199-200 (2003)). All S. invicta used in this study were from monogyne colonies.

Preparation of six Polyoxyethylene Tridecyl Ether Surfactants: Polyoxyethylene tridecyl ether (Ethal TDA) surfactants with 7.9, 11.4 and 13 HLB number were purchased from Ethox Chemical, LLC (Greenville, S.C.). Ethal TDA surfactants with 7.9, 9, 10, 11, 12, or 13 HLB number were used in this study. The surfactants with intermediate HLB numbers were made through mixing of two ETHAL-TDAs with proper HLB numbers. Compositions of the tested Ethal TDA surfactants are described in Table 1.

Topical Bioassay: Mortalities of S. invicta workers after topical treatment with Ethal TDA surfactants were determined. For ease of handling and obtaining uniform body weight, only large workers were used in the bioassay. Acetone was used as a solvent. The solution (10% w/v) was applied with a 0.779 μl capillary tube. All surfactants were tested at a concentration of 77.9 μg/ant. In the control, ants were only treated with 0.779 μl acetone. Treated ants were placed in a 30-ml capped cup at room temperature (˜23° C.) and dead ants were counted at 24 h. Three colonies were originally tested. There were 3-6 replicates for each colony. A single replicate consisted of 17 to 20 ants. In order to assess the mortality at 48 h, another three colonies were tested. For these three colonies, dead ants were counted at both 24 h and 48 h. Mortalities were adjusted using Abbott's formula (Abbott, W. S., J. Econ. Entomol., 18: 265-267 (1925)) before being used in statistical analysis. For analyzing 24 h mortality, data for all six colonies were used.

Glass-vial Bioassay: A 20-mL glass scintillation vial with metal foil cap liner (Thermo Fisher Scientific Inc., Waltham, Mass.) was treated with 0.2 mL surfactant acetone solution. The vial with cap had 44.57 cm² inner surface area. After the solution was added, the vial was capped tightly, vigorously shaken for 20 seconds, and the lid was then opened under a fume hood for 20 s. The process was repeated until acetone was completely evaporated. Control vial was treated with 0.2 mL of acetone. Once the acetone was completely evaporated, 50 worker ants were placed in the vial. The vial was capped loosely, which allowed air circulation into the vials but prevented escape. Two concentrations, 0.018 μg/cm² and 0.036 μg/cm², were tested. For each concentration, there were three replicates and ants for each replicate were from a different colony. All vials were kept at room temperature (23° C.) and dead ants were counted at 48 h. Ants were considered dead if they did not move when they were probed with a fine needle. Mortalities were adjusted using Abbott's formula (Abbott 1925) before being used in statistical analysis.

Immobilization Effect in Immersing Bioassay: Time needed to immobilize an adult ant (Ti) was measured by submerging a single ant into 2 ml surfactant water solution in a 20-ml vial and recording the time needed to immobilize the ant. The surfactant water solution was kept at 30° C. in a water bath. Immobilization status was defined as an ant that did not show any movement for at least 20 s in the solution. Workers of various sizes were tested. For each surfactant, two concentrations were tested, including 0.01% and 0.1% (w/v). Three colonies were used. Sixty workers from each colony were tested for each concentration. Each ant was placed in the solution using a fine forceps. After Ti was recorded, the ant was dried by transferring it onto a sheet of paper towel and then weighed using an analytical balance to the nearest 0.01 mg. Pure water was also tested. Since ants can float on the water surface, a different procedure was used for the pure water. The vial was completely filled with distilled water. After an ant was placed in the water, the vial was capped using a petri dish. Effort was made to ensure no air bubbles existed in the vial. The time needed to immobilize the ant was then recorded. Sixty workers from each of three colonies were tested for pure water.

Mortality in Immersing Bioassay: Mortalities of S. invicta workers after being immersed in Ethal TDA surfactants water solutions were determined. Twenty workers of various sizes were first immersed in 3 ml surfactant water solution in a 20 ml glass vial in a 30° C. water bath for 8 h, and they were then transferred into a capped plastic cup and kept at 23° C. Dead ants were counted at 24 h and 48 h. Two concentrations of surfactants, 0.01% and 0.1% (w/v), were used. Ants were randomly collected from a colony. Three colonies were used and there were three to four replicates for each combination of concentration and colony. Immersion in pure water was used as a control. Again, since ants can float on the water surface, the immersion procedure was slightly modified. After 20 ants were placed in the vial in a 30° C. water bath, the vial was completely filled with distilled water and capped with a petri dish. After all ants in the vial were immobilized, the petri dish was removed. Eight hours after being immersed, ants were then transferred into a capped plastic cup and kept at 23° C. Dead ants were counted at 24 h and 48 h.

Data Analysis: Regression analysis was conducted on mortalities in topical, glass-vial and immersing bioassays using HLB number as an explanatory variable (PROC REG; SAS/STAT® 9.2 User's Guide, 2008, Cary, N.C.: SAS Institute Inc.). For the data on immobilization effect in immersing bioassay, analysis of covariance (ANCOVA) was performed (SAS GLM procedure), in which HLB was used as independent variable and ant body mass as a covariate. Analysis of variance (SAS GLM procedure) was conducted to compare mortalities among HLB numbers and water control in immersing bioassay and means were separated using Tukey's procedure.

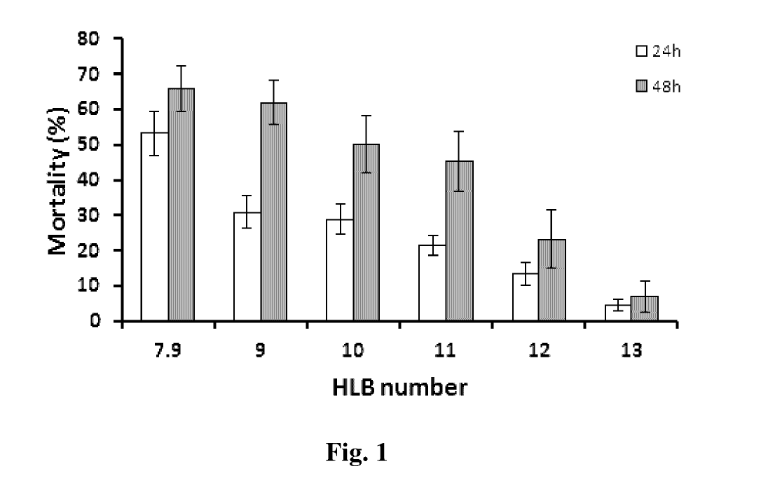

Results. Mortality in Topical Bioassay: Among six colonies used for assessing 24 h mortality, 1.67±1.05% mortality was found in the control. Among three colonies used for 48 h mortality, no mortality was found in the control. Ethal TDA surfactants caused S. invicta workers 4.68% to 53.2% mortality at 24 h and 6.95% to 65.83% mortality at 48 h at 77.9 μg/ant (FIG. 1). Since 2.27% to 31.16% of mortality occurred in the second day (from 24 h to 48 h), Ethal TDA surfactants seemed to have a slow acting property. Result of regression analysis is shown in Table 2. HLB numbers were negatively associated with mortality. HLB numbers accounted for 37% variability in 24 h mortality and 43% in 48 h mortality.

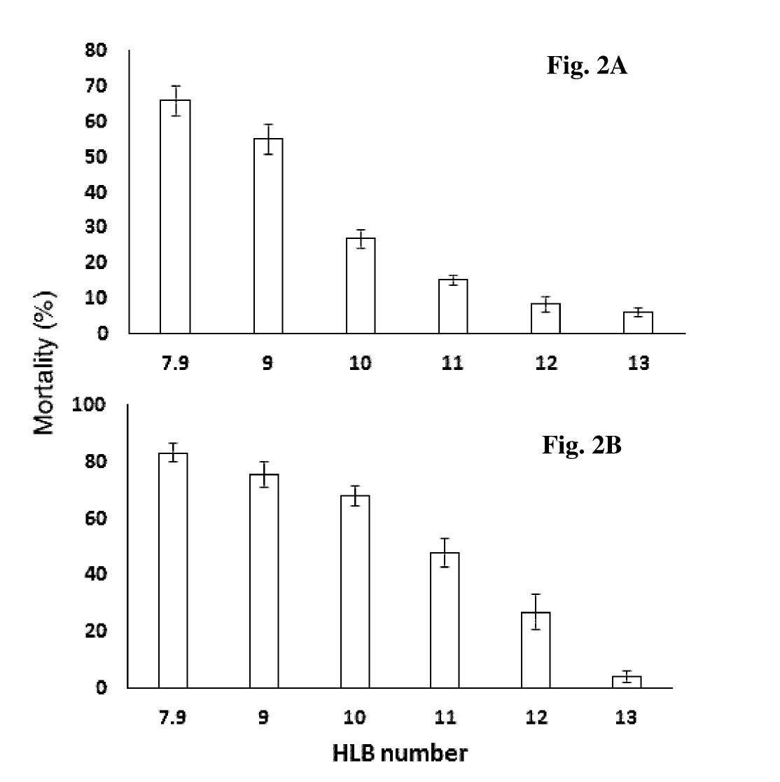

Mortality in Glass-vial Bioassay: Among three colonies, no mortality was found in the control. Ethal TDA surfactants caused S. invicta workers 6.00% to 66.00% mortality at 0.018 μg/cm² concentration and 4.00% to 83.33% mortality at 0.036 μg/cm² (FIG. 2). Result of regression analysis is shown in Table 3. HLB numbers were also negatively associated with mortality at both concentrations HLB number accounted for 81% variability in mortality at 0.018 μg/cm² concentration and 80% at 0.036 μg/cm².

Immobilization Effect in Immersing Bioassay: Water solution of all tested Ethal TDA surfactants surprisingly showed a quick immobilization effect against the immersed ant (Table 4). The data met the assumption that the slopes relating to time needed to immobilize an ant (Ti) to ant body mass were parallel for all HLB numbers. This was checked by including the class-by-covariate interaction, HLB number*body mass, in the model and examining the ANOVA test for the significance. It was not significant for both concentrations (F_{(5, 348)}=0.27, P=0.93 for 0.01% concentration and F_{(5, 348)}=1.43, P=0.21 for 0.1% concentration). Type I test was not significant for both concentrations. Type III test was not significant for 0.01% concentration but was significant for 0.1% (Table 5). It indicated that there was no significant difference in Ti among HLB numbers at 0.01% concentration whether or not ant body mass was taken into account. However, there was a significant difference in Ti at 0.1% concentration if body mass was used as a covariate (Table 5). Ti for pure water was 230.85±14.78 seconds.

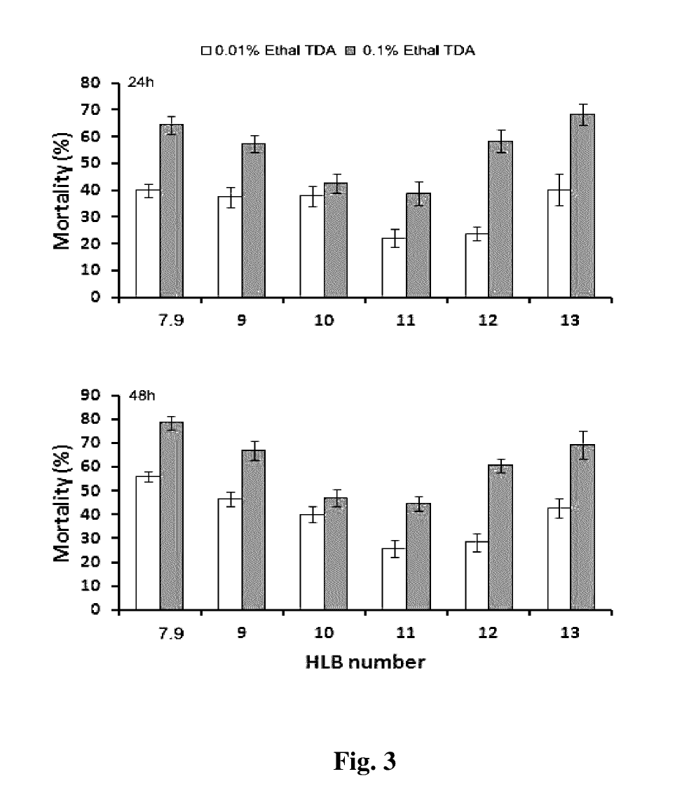

Mortality in Immersing Bioassay: After being immersed for 8 h, ants did show mortality for all tested surfactants (FIG. 3) and water control. There were significant differences in mortality among surfactants and water control at both concentrations (24 h at 0.01%: F_{6, 86}=8.71, P<0.0001; 48 h at 0.01%: F_{6, 86}=13.75, P<0.0001; 24 h at 0.1%: F_{6, 86}=24.54, P<0.0001; 48 h at 0.1%: F_{6, 86}=36.58, P<0.0001). Tukey comparisons show all surfactants caused significantly higher mortality than water control except 24 mortalities for surfactants with HLB number 11 and 12. Among three colonies, 8.89±2.00% mortality was found in the control for 24 h mortality and 10.56±1.76% for 48 mortality. Ethal TDA surfactants at 0.01% caused S. invicta workers 22.19±3.20% to 40.19±5.94% mortality at 24 h and 25.74±2.96% to 46.54±4.05% mortality at 48 h. At 0.1%, surfactants caused workers 38.77±4.42% to 68.32±3.96% mortality at 24 h and 44.75±3.39% to 78.45±2.31% mortality at 48 h. No statistically significant linear dependence of the mortality on HLB number was detected except for 48 h mortality at 0.01% concentration level, at which 14.5% variability in mortality can be explained by HLB numbers (Table 6).

Discussion: Polyoxyethylene polymers where the alkyl chain contains a minimum of six carbons are considered as inert ingredients in pesticide formulations applied to growing crops or to raw agricultural commodities after harvest. They are exempted from the requirement of a tolerance when used in accordance with good agricultural practice (U.S. National Archives and Records Administration, 2011, Code of federal regulations, Title 40, Protection of Environment). In addition, polyoxyethylene polymers are used in many household products (Household Products Database, U.S. Department of Health & Human Services, http://hpd.nlm.nih.gov/cgi-bin/household/brands?tbl=brands&id=18001082). Ethal TDA surfactants are usually used as surface active agents. This study clearly and surprisingly demonstrated that Ethal TDA surfactants were toxic to red imported fire ants, particularly those Ethal TDA surfactants with lower HLB numbers.

HLB number surprisingly was an excellent predictor of contact toxicity of Ethal TDA surfactants. The contact toxicity surprisingly decreased with the increasing HLB number. Based on the definition of HLB number (Griffin, W. C., J. Soc. Cosmet. Chem., 5: 249-256 (1954)), hydrophobic surfactants typically have low HLB numbers, whereas hydrophilic ones have high numbers. Since all tested surfactants had alkyl chain length of 13, the HLB numbers were directly proportional to the oxyethylene content of the Ethal TDA surfactants. The HLB value increased with increasing oxyethylene content.

No ants were immediately knocked down in topical bioassays. Substantial mortality occurred even after 24 h, indicating that Ethal TDA surfactants were not fast acting toxins against the red imported fire ants. However, surprisingly all water solutions of tested Ethal TDA surfactants quickly immobilized immersed ants. Without being bound by theory, fast action without dependence on HLB numbers indicated that such immobilization effect was most likely physical in nature rather than chemical. One possibility is that surfactants help the solution enter the spiracle, spread in tracheal tubes and reach each cells in the body to physically shut down the entire respiration system, which leads to a quick knockdown of ants.

Immersion in surfactant immobilized ants within minutes; however it took hours of immersion to eventually kill them. Without being bound by theory, this might be due to the slow acting nature of surfactant toxicity and the relatively low concentrations of surfactants in the immersion treatments.

We developed two emulsifiable concentrates using 2-tridecanone, soybean oil, polyoxyethylene tridecyl ether, and piperonyl butoxide (which we found surprisingly acted as a synergist). For both formulations, contact and immersion toxicity were determined in the laboratory and efficacy as mound drench treatment was assessed in the field.

Ants used in laboratory experiments: Red imported fire ant colonies were collected from Washington County, MS. Colonies were separated from soil using water dripping method (Banks, W. A., et al., Techniques for collecting, rearing, and handling imported fire ants, 1981, USDA, SEA, AATS-S-21, 9 p.) and reared in a plastic tray (44.5×60.0×13.0 cm). All colonies were ensured to be free of Kneallhazia solenopsae, a microsporidian pathogen. The social form of S. invicta colonies was determined using PCR on Gp-9 alleles (Valles, S. M., and S. D. Porter, Insectes Soc., 50:199-200 (2003)).

All ants used in laboratory bioassays were from monogyne colonies; however, social form of colonies in field mound drench treatment was not determined. Same diet (10% sugar water and house crickets) was used for rearing all laboratory colonies. Colonies were maintained in a rearing room at 25° C., 80% R.H. with a 12:12 (L:D) photoperiod.

Formulations: Two emulsifiable concentrates were prepared using 2-tridecanone ingredient, vegetable oil, and polyoxyethylene tridecyl ether as an emulsifier. Polyoxyethylene tridecyl ether surfactant with HLB number 7.9 (the smallest HLB number available for this particular type of surfactant) was used in both formulations. The compositions of two formulations are shown in Table 7.

Toxicity as soil treatment: About 1 kg of soil was collected from a fire ant mound, dried in oven under 100° C. for 24 h, and then sieved through a #35 sieve to remove debris and large particles. Ten grams of dry soil was placed in a 20-mL glass scintillation vial (Thermo Fisher Scientific Inc., Waltham, Mass.) and mixed with 0.8 ml water. Soil in vial was then pressed firmly using a wood stick. Twenty workers of various sizes were placed in the vial. Ants were allowed to settle down and dig for 12 h before 1.0 ml water solution of a test formulation was added into the vial. Glass vials were loosely capped and then placed in a 30° C. water bath. Dead ants were counted 24 h after soil was treated. Five concentrations were tested, including 0.50%, 0.25%, 0.14%, 0.06% and 0.03% (w/v). Water was used as a control. Three colonies were used. There were four replicates for each concentration.

Toxicity in immersion treatment: Mortalities of worker ants after being immersed in water solutions of a tested formulation were determined. Twenty workers of various sizes were treated by immersing ants in 5 ml solution in a 20-ml glass vial. The glass vials were placed in a 30° C. water bath. Treatment times included 0.5, 1.0, 2.0, 3.0, 4.0, and 5.0 h. After treatment, ants were transferred onto a filter paper and then into a 20-ml glass vial with a piece of moisten filter paper. The vial was loosely capped and kept at room temperature (˜23° C.). Dead ants were counted 24 h after ants were treated. Two concentrations, 0.01% and 0.1% (w/v), were tested for both formulations. Three colonies were used and there were four replicates for each concentration. Immersion in water was used as a control. Since ants can float on the water surface, the immersion procedure was slightly modified. After 20 ants were placed in the vial, the vial was completely filled with distilled water and capped with a petri dish. After all ants in the vial were immobilized, the petri dish was removed.

Field experiment (mound drench): Both formulations were tested as a mound drench along with water-only as a negative control and registered insecticide, Entrust® SC Naturalyte® Insect Control (22.5% spinosad, Dow AgroSciences LLC, Indianapolis, Ind.), as a positive control. Two applications rates, 5.28 mL/L and 2.64 mL/L, were tested. For mounds less than 20.32 cm in diameter, 3785 ml of emulsion was used for each mound. For mounds 20.32 cm or larger, 7570 ml of emulsion was used. The Entrust® SC was applied per label instruction (0.39 μl/ml). The final spinosad concentration in the suspension was 0.0088%. The study was conducted in Leroy Percy Wildlife Management Area, Hollandale, Miss. A colony was randomly assigned to a treatment or control. Each treatment or control had 15 to 16 replicates (mounds). Mounds were measured one week before the experiment. The widest aspect of a mound was recorded as its size. All mounds had a minimum size of 10 cm and all mounds were minimum 4 m apart. One day before treatment, ant activity was evaluated for each mound between 7:00 am and 9:00 am. A wood rod was inserted into the center of the mound at depth of 10 cm. After 10 seconds, the rod was removed from the mound and ants on the rod were dislodged into a container and counted. Treatments or controls were applied between 7:00 am and 10:00 am when ants were in the upper part of the mound. All treatment or controls were applied using a 10-L plastic container. About 10% of the dilution or water was first applied around the perimeter of the mound and the remaining volume was directly applied on the mound. Ant activities were then measured 1, 3, 8, and 14 days after treatment. Relocated mounds that were formed after treatment and within a 1.5-m radius of the original mound were inspected, their sizes and ant activity measured. Mounds were scored according to a system (Table 2) adapted from Vogt et al. (Vogt, J., et al., J. Ag. and Urban Entomology, 19(3): 159-171 (2002)).

Data analysis: Polo Plus (Version 2.0, LeOra Software, Petaluma, Calif.) was used to estimate LC₅₀, with 95% confidence interval (CIs). The relative toxicity ratio with their upper and lower 95% confidence limits was used to evaluate the significance of difference between LC₅₀ values. The significance was set at P=0.05 probability level. If the 95% confidence interval of the ratio between two LC₅₀ values include 1, they were not considered significantly different (Robertson, J. L., et al., Bioassays with Arthropods, second edition, CRC Press, Boca Raton, Fla. (2007). Analysis of variance (PROC GLM; SAS Institute 2008) was performed for field experiment data for each day of measurement and means were separated using Tukey's Multiple Comparison Test (P<0.05).

Results. Toxicity in soil treatment: The LC₅₀ values for both formulations are presented in Table 9. LC₅₀ value ranged from 0.066 to 0.102 mg/g for formulation A and 0.039 to 0.070 mg/g for formulation B. For both formulations, LC₅₀ values were significantly different among three colonies. For formulation A, it needed 0.214 mg/g in soil to cause 100% mortality for colony 1 and 2 and 0.430 mg/g for colony 3. For formulation B, it needed 0.107 mg/g to cause 100% mortality for colony 2 and 0.214 mg/g for colonies 1 and 3.

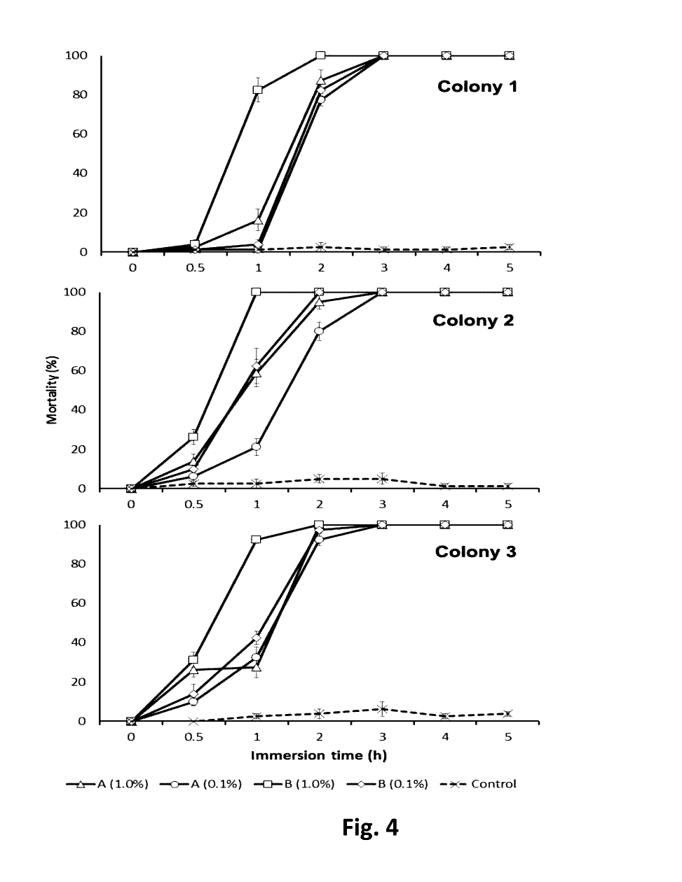

Toxicity in immersion treatment: The LT₅₀ values for both formulations are shown in Table 10. Formulation B surprisingly had higher immersion toxicity than formulation A. Three data sets were not adequate for calculating LT₅₀ values: formulation A at 0.1 mL/L for colony 1 and formulation B at 0.1 mL/L for colony 1 and at 1.0 mL/L for colony 2. Within a colony, all available pairwise comparison indicated that formulation B surprisingly always had smaller LT₅₀ value than formulation A at the same concentration level. For each formulation, the higher its concentration, the smaller its LT₅₀ value. Mean mortalities of workers in immersion bioassay are shown in FIG. 4. For formulation A, except colony 3 at the concentration of 0.01% that needed 2 h to cause 100% mortality, all other treatments need 3 h, whereas for formulation B, colony 2 at 0.1% only needed 1 h, other three treatments needed 2 h and only two treatments at 0.01% need 3 h.

Field experiment (mound drench): Both formulations caused significant ant activity reduction. Fourteen days after treatment, all treatments including two formulations and the positive control all had significantly greater ant activity reduction (Table 11) and smaller mound scores (Table 12) than the water control. Although the difference among those treatments were not statistically significant, surprisingly only formulation B at 0.26% achieved a complete control (100% activity reduction and mound score as 1.0). The positive control (Entrust® SC) had 88.06% activity reduction and 1.40 mound score and the negative control, water drench, had 25.50% activity reduction and 3.27 mound score. All treatment caused satellite mounds; however, only formulation B at 0.26%, surprisingly all satellite mounds died out within 14 days.

Discussion: Due to the concern about the negative environmental impact of traditional synthetic insecticides, homeowners have an ever-increasing interest in the use of less toxic or “organic” products for fire ant control. In this study, both formulations surprisingly achieved significant fire ant control at a very low application rate (5.28 mL/L). At this application rate, surprisingly no phytotoxicity to the grasses was observed in the field experiment. Based on the price of each component at time of purchase, the cost per mound was $0.58 for formulation A and $0.57 for formulation B, which are cheaper than many commercially available mound drench products, including Entrust® SC and two d-limonene based products (Table 13).

We also tested the toxicity of piperonyl butoxide (PBO) against red imported fire ants. Three doses were used 0.46, 0.93, and 9.3 (μg/ant). Topical bioassay as described above was used: Mortalities of S. invicta workers after topical treatment with PBO were determined. For the ease of handling and obtaining uniform body weight, only large workers were used in the bioassay. Acetone was used as a solvent. Treated ants were placed in a 30-ml capped cup at room temperature (˜23° C.) and dead ants were counted at 24 h. Three colonies were tested. There were three replicates for each colony. A single replicate consisted of 14 to 16 ants. The data is summarized in Table 14. At 0.93 (μg/ant), no mortality was observed for all three colonies. At 9.3 (μg/ant), ≦4.60% mortality was observed for two colonies and no mortality for the other colony.

The effect of PBO to 2-tridecaone was tested at 0.93 (μg/ant) using topical bioassay. Three colonies were tested. Since the data for one colony was not suitable for calculating LD50 values (2-tridecanone+PBO treatment), the data from the other two colonies are summarized in Table 15. Surprisingly PBO was a significant synergist to 2-tridecanone.

In summary, due to their surprising contact toxicity and quick immobilization effect, Ethal TDA surfactants, particularly those with small HLB numbers, may be useful in developing control products for insects such as red imported fire ants. They can be useful in mound treatment products, particularly in liquid formulations for mound drench, which will take advantage of both contact toxicity and fast immobilization effect of the surfactant. Fast immobilization may prevent or slow down the escape of ants from the treated area and enhance the contact of ants with active ingredients. Surfactants may also be useful in immersion treatment for imported fire ant quarantine, since submerging quarantined items in a surfactant solution for a prolonged time may be practical. One assumable approach is first to submerge quarantined items in surfactant solution to kill ants and then to spray insecticide on the surface to prevent ants from re-entering the treated item. This may significantly reduce the use of synthetic insecticides in quarantine treatments since bulk amounts of insecticide solution for immersion may be no longer necessary.

All of the references cited herein, including U.S. patents, are incorporated by reference in their entirety. Also incorporated by reference in their entirety are the following references: Appel, A. G., et al., J. Econ. Entomol., 97: 575-580 (2004); Boeije, G. M., et al., Ecotox. Environ. Safe., 64: 75-84 (2006); Chen, J., J. Entomol. Sci., 40: 368-377 (2005); Chen, J., J. Agr. Food Chem., 57: 618-622 (2009); Chen, J., et al., J. Econ. Entomol., 101: 265-271 (2008); Cheng, S. S., et al., Bioresource Technol., 99: 889-893 (2008); Cserháti, T., Environ. Health Persp., 103: 358-364 (1995); Maki, A. W., and W. E. Bishop, Arch. Environ. Contam. Toxicol., 8: 599-612 (1979); McKee, F. R., et al., Environ. Entomol., 38: 1387-1394 (2009); Müller, M. T., et al., Environ. Toxicol. Chem., 18: 2767-2774 (1999); Rostás, M., and K. Blassmann, Proc. R. Soc. London. Ser B, 276: 633-63 (2009); Wong, D. C., et al., Environ. Toxicol. Chem., 16: 1970-1976 (1997); Vogt, J., et al., J. Agri. Urban Entomol., 19: 159-171 (2002); Cheng, S. S., et al., Bioresource Technol., 99: 889-893 (2008); Appel, A. G., et al., J. Econ. Entomol., 97: 575-580 (2004); Kramer, K. J., et al., J. Kans. Entomol. Soc., 58: 254-260 (1985); Lin, S. Y. H., et al., J. Chem. Ecol., 13: 837-850 (1987); Braga, Y. F. B., et al., An. Acad. Bras. Ciênc, 79: 35-39 (2007); Williams, W. G., et al., Science, 207: 888-889 (1980); Weston, P. A., et al., J. Am. Soc. Hortic. Sci., 114: 492-498 (1989); Chatzivasileiadis, E. A., and M. W. Sabelis, Exp. Appl. Acarol., 21: 473-484 (1997); Williams, W. G., et al., Science, 207: 888-889 (1980); Antonious, G. F., and J. C. Snyde, Tomato leaf crude extracts for insects and spider mite control, IN: Tomatoes and Tomato Products Nutritional, Medicinal and Therapeutic Properties, ed. by Preedy, V. R., and R. R. Watson, Science Publishers, Enfield, N.H., pp. 269-297 (2008); Burdock, G. A., Fenaroli's Handbook of Flavor Ingredients, Sixth Edition, CRC Press, Boca Raton, Fla., (2010); Ogunbinu, A. O., et al., J. Essent. Oil Res., 19: 4, 362-363 (2007); Cowles, R. S., et al., J. Econ. Entomol., 93: 180-188 (2000); Imai, T., et al., Appl. Entomol. Zool., 29: 389-393 (1994); Olkowski, W., et al., Common-sense pest control., 1991, Newtown, The Taunton Press; Sims, S. R., and A. G. Appel, J. Econ. Entomol., 100: 871-879 (2007); Wood, B. W., et al., Hortscience, 32: 1074-1076 (1997); Imai, T., et al., Appl. Entomol. Zool., 30: 380-382 (1994).

Thus, in view of the above, there is described (in part) the following:

A composition for killing and/or immobilizing insects, said composition comprising (or consisting essentially of or consisting of) 2-tridecanone, at least one solvent, at least one surfactant, piperonyl butoxide, and optionally a carrier. The above composition, wherein said at least one solvent is vegetable oil. The above composition, wherein said at least one surfactant is polyoxyethylene tridecyl ether having a hydrophilic-lipophilic balance number from about 7 to about 13. The above composition, wherein said HLB hydrophilic-lipophilic balance number is below about 12. The above composition, wherein said HLB hydrophilic-lipophilic balance number is below about 11. The above composition, wherein said HLB hydrophilic-lipophilic balance number is below about 10. The above composition which does not contain fungi.

A method for killing and/or immobilizing insects, said method comprising (or consisting essentially of or consisting of) treating an object (includes the insects themselves) or area with an insect killing effective amount or insect immobilizing effective amount of a composition comprising 2-tridecanone, at least one solvent, at least one surfactant, optionally butoxide, and optionally a carrier.

The term “consisting essentially of” excludes additional method (or process) steps or composition components that substantially interfere with the intended activity of the method (or process) or composition.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

TABLE 1
Compositions of tested Ethal TDA surfactants.

| HLB | % Ethal TDA 3 | % Ethal TDA 6 | % Ethal TDA 9 |
|---|---|---|---|
| Number | (HLB = 7.9) | (HLB = 11.4) | (HLB = 13) |
| 7.9 | 100 | 0 | 0 |
| 9 | 68.6 | 31.4 | 0 |
| 10 | 40 | 60 | 0 |
| 11 | 11.4 | 88.6 | 0 |
| 12 | 19.6 | 0 | 80.4 |
| 13 | 0 | 0 | 100 |

TABLE 2
Result of regression analysis of mortality data in topical bioassay.

| | | Parameter | | | |
|---|---|---|---|---|---|
| Mortality | Vari- | estimated | 95% | t | P |
| type | able | (SE) | CL | Value | Value |
| 24 h | Inter- | 116.25 (10.41) | 95.68-136.83 | 11.7 | <0.001 |
| | cept | | | | |
| | HLB | −8.65 (0.98) | −10.59-−6.71 | −8.85 | <0.001 |
| | number | | | | |
| 48 h | Inter- | 166.96 (17.99) | 131.03-202.89 | 9.28 | <0.001 |
| | cept | | | | |
| | HLB | −11.87 (1.69) | −15.25-−8.50 | −7.02 | <0.001 |
| | number | | | | |

r² was 0.37 and 0.43 for 24 h and 48 h mortality respectively.

TABLE 3
Result of regression analysis on mortality
data in glass-vial bioassay.

| | | Parameter | | | |
|---|---|---|---|---|---|
| Concen- | Vari- | estimated | 95% | t | P |
| tration | able | (SE) | CL | Value | Value |
| 0.018 | Inter- | 163.37 (9.07) | 145.17-181.57 | 18.01 | <0.001 |
| μg/cm² | cept | | | | |
| | HLB | −12.77 (0.85) | −14.48-−11.05 | −14.95 | <0.001 |
| | number | | | | |
| 0.036 | Inter- | 216.81 (11.77) | 193.20-240.42 | 18.43 | <0.001 |
| μg/cm² | cept | | | | |
| | HLB | −15.82 (1.11) | −18.05-−13.60 | −14.29 | <0.001 |
| | number | | | | |

r² was 0.80 and 0.81 for 0.018 μg/cm² and 0.036 μg/cm² respectively.

TABLE 4
Time needed to immobilize a worker ant
(Tᵢ) in water solution of surfactant.

| HLB | Concen- | Ti |
|---|---|---|
| number | tration | (SE)(second)* |
| 7.9 | 0.01 | 66.83 (4.62) |
| | 0.1 | 52.85 (3.48) |
| 9 | 0.01 | 66.88 (5.61) |
| | 0.1 | 64.28 (5.26) |
| 10 | 0.01 | 64.22 (4.17) |
| | 0.1 | 66.40 (4.72) |
| 11 | 0.01 | 65.13 (4.27) |
| | 0.1 | 66.27 (4.85) |
| 12 | 0.01 | 64.42 (4.78) |
| | 0.1 | 70.43 (6.41) |
| 13 | 0.01 | 70.88 (5.83) |
| | 0.1 | 66.60 (4.23) |

*Tᵢ for pure water was 230.85 ± 14.78 (mean ± SE).

TABLE 5
Result of analysis of covariance (ANCOVA) on the time
needed to immobilize worker ants in immersing bioassay.

| Concen- | | | | |
|---|---|---|---|---|
| tration | Type | Mean | F | P |
| (%, w/v) | I SS | Square | Value | Value |
| 0.01 | 1849.59 | 369.92 | 0.35 | 0.88 |
| 0.1 | 10926.62 | 2185.32 | 1.96 | 0.085 |
| Concen- | | | | |
| tration | Type | Mean | F | P |
| (%, w/v) | III SS | Square | Value | Value |
| 0.01 | 3260.03 | 652.01 | 0.62 | 0.69 |
| 0.1 | 14804.86 | 2960.97 | 2.65 | 0.023 |

TABLE 6
Result of regression analysis on 24 h and 48 h mortalities of Solenopsis invicta
workers after being immersed in two concentrations of water solutions
of Ethal TDA surfactants with different HLB numbers for 8 h.

| Conc. | Mortality | | Est. parameter | | | | |
|---|---|---|---|---|---|---|---|
| (%, w/v) | type | Variable | (SE) | | 95% CL | t Value | P Value |
| 0.01 | 24 h | Intercept | 50.09 | (10.59) | 29.02-71.57 | 4.73 | <0.001 |
| | | HLB number | −1.57 | (1.00) | −3.14 | −1.58 | 0.12 |
| | 48 h | Intercept | 80.62 | (11.07) | 58.60-102.63 | 7.28 | <0.001 |
| | | HLB number | −3.88 | (1.04) | −5.95-−1.81 | −3.73 | 0.0004* |
| 0.1 | 24 h | Intercept | 49.18 | (11.92) | 25.47-72.88 | 4.13 | <0.001 |
| | | HLB number | 0.55 | (1.12) | −1.68-−2.78 | 0.49 | 0.63 |
| | 48 h | Intercept | 81.47 | (11.62) | 58.36-104.59 | 7.01 | <0.001 |
| | | HLB number | −1.93 | (1.09) | −4.11-0.24 | −1.77 | 0.24 |

*r² = 0.145, P = 0.0004.

TABLE 7
Composition of two emulsifiable concentrates of 2-tridecanone.

| Formu- | | Percentage |
|---|---|---|
| lation | Component | (w/w) |
| A | 2-tridecanone | 30 |
| | Soybean oil | 30 |
| | Ethal TDA | 40 |
| B | 2-tridecanone | 20 |
| | Soybean oil | 20 |
| | Ethal TDA | 40 |
| | PBO | 20 |

TABLE 8
Score system used to evaluate the
effect of mound drench treatment.*

| Score | Treated mound alive? | Number of new mounds <1.5 m away |
|---|---|---|
| 1 | no | 0 |
| 2 | no | 1 |
| 3 | no | 2 |
| 4 | yes | 0 |
| 5 | yes | 1 |
| 6 | yes | 2 |

*adapted from Vogt et al.

TABLE 9
Toxicity of two formulations in soil treatment bioassay.

| | Formu- | LC₅₀ | 95% | Slope | |
|---|---|---|---|---|---|
| Colony | lation | (mg/g) | CI | (±SE) | X² |
| 1 | A | 0.066 | 0.056-0.074 | 5.072 ± 0.73 | 8.79 |
| | B | 0.047 | 0.040-0.054 | 4.64 ± 0.62 | 16.18 |
| 2 | A | 0.089 | 0.055-0.110 | 4.47 ± 0.89 | 28.64 |
| | B | 0.039 | 0.034-0.043 | 6.16 ± 0.89 | 3.88 |
| 3 | A | 0.102 | 0.077-0.123 | 3.52 ± 0.46 | 24.24 |
| | B | 0.07 | 0.061-0.078 | 5.18 ± 0.65 | 17.78 |

TABLE 10
Toxicity of two formulations in immersion treatment bioassay.

| | | Conc | LT₅₀ | | Slope | |
|---|---|---|---|---|---|---|
| Colony | Formulation | (mL/L) | (h) | 95% CI | (±SE) | χ₂ |
| 1 | A | 1 | 1.32 | 1.18-1.47 | 6.33 ± 0.55 | 35.45 |
| | | 0.1 | —* | — | — | — |
| | B | 1 | 1.17 | 0.91-1.40 | 7.34 ± 0.75 | 81.22 |
| | | 0.1 | — | — | — | — |
| 2 | A | 1 | 0.88 | 0.79-0.96 | 4.72 ± 0.43 | 15.66 |
| | | 0.1 | 1.28 | 1.15-1.41 | 5.01 ± 0.39 | 26.25 |
| | B | 1 | — | — | — | — |
| | | 0.1 | 0.85 | 0.78-0.92 | 6.04 ± 0.63 | 16.45 |
| 3 | A | 1 | 0.92 | 0.77-1.08 | 4.23 ± 0.36 | 52.44 |
| | | 0.1 | 1.07 | 0.98-1.17 | 4.94 ± 0.40 | 17.66 |
| | B | 1 | 0.6 | 0.54-0.65 | 6.44 ± 0.82 | 2.34 |
| | | 0.1 | 0.95 | 0.86-1.04 | 4.93 ± 0.43 | 19.6 |

*Data was not adequate for calculating LT₅₀.

TABLE 11
Ant activity reduction after mound drench treatment.

| Formu- | Ant activity reduction ^{a} (%, mean ± SE) * | | | | | | | |
|---|---|---|---|---|---|---|---|---|
| lation | 1 day | | 3 day | | 8 day | | 14 day | |
| A (0.26%) | 88.98 ± 5.25 | a | 77.20 ± 8.88 | a | 73.06 ± 10.13 | a | 88.03 ± 8.98 | a |
| A (0.13%) | 79.39 ± 6.50 | a | 73.71 ± 11.55 | a | 71.38 ± 16.73 | a | 78.05 ± 8.49 | a |
| Entrust ® SC | 80.03 ± 6.42 | a | 89.24 ± 5.89 | a | 90.31 ± 6.61 | a | 88.06 ± 8.79 | a |
| B (0.26%) | 98.81 ± 1.19 | a | 81.62 ± 12.93 | a | 96.00 ± 4.00 | a | 100.00 ± 0.00 | a |
| B (0.13%) | 88.85 ± 5.33 | a | 75.16 ± 9.03 | a | 79.54 ± 11.13 | a | 96.28 ± 2.53 | a |
| Water | 31.14 ± 17.99 | b | 30.08 ± 12.57 | b | 12.84 ± 19.62 | b | 25.50 ± 16.19 | b |

* Under the same day, means followed by the different letter are significantly different (P < 0.05).

TABLE 12
Mean mound score after mounds were drenched
with two formulations, Entrust SC and water.

| Formu- | Mound score ^{a} (mean ± SE) * | | | | | |
|---|---|---|---|---|---|---|
| lation | 1 day | | 3 day | | 8 day | 14 day |
| A (0.26%) | 2.13 ± 0.36 | bc | 2.53 ± 0.42 | ab | 2.13 ± 0.38 b | 1.40 ± 0.21 b |
| A (0.13%) | 3.27 ± 0.33 | ab | 2.73 ± 0.45 | ab | 1.60 ± 0.29 b | 2.07 ± 0.37 b |
| Entrust ® SC | 3.40 ± 0.32 | a | 2.07 ± 0.42 | ab | 1.20 ± 0.15 b | 1.40 ± 0.34 b |
| B (0.26%) | 1.31 ± 0.20 | c | 1.44 ± 0.16 | b | 1.06 ± 0.06 b | 1.00 ± 0.00 b |
| B (0.13%) | 2.07 ± 0.37 | bc | 2.13 ± 0.41 | ab | 1.60 ± 0.27 b | 1.27 ± 0.21 b |
| Water | 4.07 ± 0.07 | a | 3.40 ± 0.35 | a | 3.33 ± 0.36 a | 3.27 ± 0.37 a |

* Under the same day, means followed by the different letter are significantly different (P < 0.05).

TABLE 13
Cost of two formulations and some commercial products
used for S. invicta mound drench.*

| | | Application | Cost per |
|---|---|---|---|
| | | Rate | mound |
| Product | A.I. | (mL/L) | ($) |
| Formulation A | 2-tridecanone | 5.26 | 0.58 |
| Formulation B | 2-tridecanone | 5.26 | 0.57 |
| Entrust SC | spinosad | 0.39 | 1.33 |
| Garden-Ville | d-limonene | 47.1 | 0.8 |
| Soil Conditioner | | | |
| Citrex Fire Ant Killer | d-limonene | 236.6 | 3.87 |
| Otho Fire Ant Killer | Acephate | 1.95 | 0.31 |
| Terro Fire Ant Killer | Deltamethrin | 1.95 | 0.18 |
| Sevin Concentrate | Carbaryl | 5.84 | 0.69 |
| Bug Killer | | | |
| Hi Yield Garden, | Permethrin | 11.67 | 1.5 |
| Pet, & Livestock | | | |
| Insect Control | | | |
| Ferti-lome, Bore, | spinosad | 15.57 | 4.23 |
| Bagworm Tent Caterpillar | | | |
| & Leafminer Spray | | | |

*cost for two tested formulations was calculated based on the price of each component at time of purchase. Cost for Entrust SC was calculated based on the market price of the product and recommended application rate. Cost for other products were from the literature.

TABLE 14
Mortality caused by PBO only.

| | |
|---|---|
| PBO Dose | Mortality |

| (μg/ant) | Colony | Mean | SE |
|---|---|---|---|
| 0.46 | 1 | 0.00 | 0.00 |
| | 2 | 0.00 | 0.00 |
| | 3 | 2.22 | 2.22 |
| 0.93 | 1 | 0.00 | 0.00 |
| | 2 | 0.00 | 0.00 |
| | 3 | 0.00 | 0.00 |
| 9.3 | 1 | 0.00 | 0.00 |
| | 2 | 4.60 | 2.31 |
| | 3 | 2.22 | 2.22 |

TABLE 15
Synergetic effect of PBO to 2-tridecanone.

| | PBO | | | | | |
|---|---|---|---|---|---|---|
| | Conc | LD₅₀ | | Slope | | |
| Colony | (μg/ant) | (μg/ant) | 95% CI | (±SE) | χ² | SR* |
| 288 | 0 | 18.96 | 16.67-20.45 | 10.23 (1.86) | 14.48 | — |
| | 0.93 | 2.28 | 1.15-3.10 | 3.03 (0.54) | 26.9 | 8.31 |
| 295 | 0 | 22.82 | 20.96-24.55 | 5.96 (0.80) | 12.71 | — |
| | 0.93 | 6.23 | 5.09-7.45 | 2.89 (0.43) | 8.88 | 3.66 |

SR = LC₅₀ (2-tridecanone only)/LC50 (2-tridecanone + PBO)

We claim:

1. A composition for killing and/or immobilizing insects, said composition comprising 2-tridecanone, at least one solvent, at least one surfactant, piperonyl butoxide, and optionally a carrier.

2. The composition according to claim 1, wherein said at least one solvent is vegetable oil.

3. The composition according to claim 1, wherein said at least one surfactant is polyoxyethylene tridecyl ether having a hydrophilic-lipophilic balance number from about 7 to about 13.

4. The composition according to claim 3, wherein said hydrophilic-lipophilic balance number is below about 12.

5. The composition according to claim 3, wherein said hydrophilic-lipophilic balance number is below about 11.

6. The composition according to claim 3, wherein said hydrophilic-lipophilic balance number is below about 10.

7. A method for killing and/or immobilizing insects, said method comprising treating an object or area with an insect killing effective amount or insect immobilizing effective amount of a composition comprising 2-tridecanone, at least one solvent, at least one surfactant, optionally butoxide, and optionally a carrier.
